(19) United States
(12) Patent Application Publication
(10) Pub. No.: US 2005/0159151 A1
(43) Pub. Date: Jul. 21, 2005

(54) Communication system for passengers in transport

(76) Inventor: Manfred Eckelt, Mainz (DE)

Correspondence Address: Robert W Becker & Associates, Suite B, 707 Highway 66 East, Tijeras, NM, 87059, US

(21) Appl. No.: 10/505,904

(22) PCT Filed: Feb. 27, 2003
(86) PCT No.: PCT/DE03/00622

(30) Foreign Application Priority Data
Feb. 28, 2002 (DE) 102-08-934.5

(51) Int. Cl. H04Q 7/20

(52) U.S. Cl. 455/431; 455/422.1

(57) ABSTRACT

The invention relates to a communication system for passengers in a means of transport, such as an aeroplane, train, bus or ship. In order to provide a communication system for business passengers whereby said passengers can work comfortably during their journey and can obtain and send necessary data and information in a rapid manner, said communication system comprises the following components: a) at least one communication device (1) on the passenger seat (2), b) at last one on-board server (3) in the means of transport (20), c) one or more base servers (4,4′) arranged on one or more base stations (5,5′) of the means of transport (20). The communication device (1) is used by the passengers in the communication system for inputting information and for outputting information which can be received by the passenger either visually and/or acoustically. The on-board server (3) and the communication system (1) are configured for wireless and/or wire bound exchange of data with one or more base servers (4, 4′) at one or more base stations (5, 5′) and the base server or servers (4, 4′) at one or more base stations (5, 5′) is connected to an open and/or closed network (Internet, Intranet) for data exchange.

The present invention relates to a communication system for passengers in a transport facility like aircraft, train, bus or ship.

In recent times possibilities of telecommunication for passengers in public transport facilities are very limited. In railway systems often only a few card phones are available since they increasingly lose their importance due to the growing circulation of private mobile phones.

Since due to safety reasons the use of mobile phones in aircrafts is generally not allowed, many airline provide their passengers with backrest-mounted telephones. These telephones normally do have magnet card readers and the billing of calls will be made via passenger's credit cards.

Passengers on a business trip often use the travel time for working and therefore they take a personal computer like notebook, laptop etc. along into the transport vehicle. On this computer the passenger has software programs like text editing, chart calculation etc. as well as own files available. Prior to departure the passenger has to transfer the necessary files on his computer to have them available during the travel. Only upon arrival the passenger is in a position to transfer his prepared data, letters, e-mails etc. via one of the wired network systems or by connecting his computers into the company's network. Meanwhile there also exist possibilities to transfer data during a trip via mobile phones wireless although the use of those connections are limited due to their low transfer rate and since use of personal mobile phones inside aircrafts is not allowed.

Preferably passengers on business travels have a need for a comprehensive communication system which they can work with during the trip and can send and receive necessary information.

It is an object of the present invention to provide a communication system of the prior art whereby the communication system at least provides the following components:
a) at least one communication device at the passenger seat
b) at least one onboard server in the transport facility
c) one or more base servers at one or more base stations of the transport system
   whereby
the communication device is provided for data inputs by the passenger to the communication system and for data outputs from the communication system which the passenger can receive optically or acoustically, the onboard server and the communication device is provided for a wireless and/or wired data exchange with each other,
the onboard server is provided for a wireless and/or wired data exchange with one or more base servers for a wireless and/or wired data exchange with one or more base servers at one or more base stations and
one or more base servers at one or more base stations are linked for a data exchange to an open and/or closed network (Internet, Intranet).

The communication system of the present invention is in a position to provide the traveling passenger a virtual office, whereby he (she) is able to let data and information appear via the communication device, accordingly to work, store or lead to one or more selected receiver stations: Passengers have the opportunity to receive their own data and information during the travel.

Depending on the feature of the inventive communication system the passenger will be provided in addition with particular or diverse of following described communication applications.

Thus the inventive communication system provides the passenger via the communication device the opportunity for example to order meals, to make seat adjustments, to switch the light on and off, to activate the attendance call, to order and to pay for goods, to fill out and to send travel forms especially immigration forms, to use the Internet, to make calls, to attend video conferences, to do PC works, to use information services and entertainment programs.

In a preferred form of the invention the communication system is designed in a way that the communication device has features of controlling the functions of passenger seats itself like adjustments of seat positions, seat heating as well of controlling of functions around the seat like lighting, air conditioning etc. Seat adjustments can be operated via the communication device at the passenger seat for example by moving symbolic seat operating buttons. If preferences of the passenger for different seat adjustments are known in the onboard server for example for positions for lunching, reading or sleeping the appropriate symbol on the screen will be activated and the seat automatically moves into the preferred position. Light at the passenger seat can be switched on and off via a switch operating button at the communication device. The attendance call can be managed via a bell operating button, which is displayed on the communication device whereby the flight attendant automatically will receive the seat position of the passengers.

Thus in addition the present inventive communication system can preferably be designed such that passengers can order meals and beverages via the communication device. Meals offered by the transport company will be displayed on the communication device. In case of possibilities of choices meals and beverages can be selected and ordered. This information will be displayed on a service screen in the pantry of the transport vehicle. Then the service can be executed individually. The ordering of meals or beverages for a booked travel, for example a flight, can be achieved online via internet and intranet by e-mail prior to the start of the travel as it is usual today for kosher and diet meals. The more this would be the use on standard catering the more precise the loading of the transport vehicle with food and beverages can be managed and unnecessary weight can be avoided.

Goods for example customs free goods which can be purchased on flights or cruises are displayed for the passenger on the communication device. He (she) can select goods via the communication device, order and pay for example by credit cards. The delivery of the goods to the passenger can optionally be managed directly in the transport vehicle, after leaving of the transport vehicle at the station or by delivery service after the travel to the home address or every other address stated by the passenger. Besides the buy in the transport vehicle the passenger also can release an online order prior to the travel.

In a preferred form of the present inventive communication system the passenger has a direct access to the world wide Internet. For this the base server at base stations with link to the Internet are available for a direct data exchange. The passenger via the communication device has appropriate Internet software available, like Internet browser, e-mail programs, FTP-software etc. Requests to the Internet or data to be sent via Internet will be transferred via the communication device at the passenger seat to the central onboard server at the transport vehicle via a data line in the transport vehicle or also via wireless with a radio transmission.

The onboard server in the transport vehicle has a bi-directional connection to one or more base servers at base stations for data exchanges and leads requests of data of the passenger to these. The connection between the onboard server at the transport vehicle and the base server can be a direct radio connection or preferably also indirectly via satellite. Requests and data sent by the passenger can be directed from the base servers directly to the Internet. Internet contents or data requested by the passenger will be received by the base server and be transmitted to the onboard server in the transport vehicle, which directs these to the communication device at the passenger seat. An advantage of this communication system is that the passenger can communicate and exchange data during the whole travel time without taking into account the delay of the travel duration. In addition the system has the advantage that the passenger has not to file all data and information to be needed for his work already prior to travel for example into a pocket computer to be in a position to have these available during the travel. He is also in a position to manage the access to the company network via Internet by various currently available procedures.

The use of the Internet or other network offers for example the access to the Intranet of the transport company can as well be managed online as also offline. Online connection from aircraft to the Internet or Intranet during the flight needs the availability of an appropriate satellite infrastructure and aircrafts equipped with special antennas for the receiving. Depending on the availability of the data connection an automatic change between online- and offline modus can be managed. This change of the online- and offline modus often depending on the movement pattern can be used to load information requested by the passenger on the server and therefore to guarantee a maximum on actuality and network availability. This application represents an optimization on the use of networks which is not sufficient today for mobile phoning with interruptions of calls due to radio holes or intended service restrictions caused by so-called roaming. Offline connections for the majority of cases have a sufficient actuality for the user of a transport system. They allow the passenger of a transport vehicle during the travel to take from the onboard server a multitude of data which have been accumulated prior to departure like e-mails, SMS etc. and eventually to work with or to respond. Papers which are worked with offline during the travel can be transferred automatically upon arrival at the destination.

Experience shows preferably the communication device of the communication system contains a screen especially preferred a liquid crystal display for the visual outputs. In addition the present inventive communication device appropriately contains an integrated loudspeaker or a wireless or wired headset connected to the communication device for acoustical outputs. For inputs of data or commands of the passengers the communication device contains one or more of the following input features: computer keyboard and/or a touch screen and/or a microphone and/or a computer mouse. Especially preferred are loudspeaker respectively headphone and microphone in an integrated headset which is linked to the communication device. Herewith the passenger can make calls as usual and also control the communication device by voice. In addition the passenger receives the tone of the entertainment programs as radio programs, music, sound of video movies etc. as well announcements of the service staff.

In addition it is appropriate to provide a fixture at the passenger seat that is designed for the communication device, preferably a flexible and swiveling arm, which is designed in a way, that the communication device can be removably attached. To avoid not to hold the communication device in the hands during the whole travel or to deposit within the rage of sight in an insecure way, a flexible mounting device is appropriate. This should be designed with an appropriate mounting device for example a plug-in connection for easy removable but secure mounting of the communication device. The connection to the other fixed point of the mounting device for example at the seat or armrest of the passenger seat is designed in a way that this is flexible and/or swiveling to all directions. By means of the mounting device the communication device can be deposited in sight of the passenger in any wanted position. As an advantage it is designed in a way that it doesn't transmit vibrations on the screen. Alternatively the mounting of the communication device can also be designed on the seat tablet of the passenger seat which is either attached to the backrest of the front seat or to the armrest of the passenger seat.

In an especially preferable application form of the invention a slot is designed at the passenger seat, preferably at the armrest of the passenger seat, to store the communication device whereby the slot preferably is equipped with a charging station for the recharging of the battery equipped communication device. This charging station is designed in the slot in a way that during the plug-in of the communication device the electrical connectors of the charging station and the communication device will be connected to one another.

In a preferred form of the invention the communication device is equipped with a webcam via which the passengers can attend video conferences online.

For PC work a corresponding software library will be provided to the passenger on the onboard server or directly to the communication device at the passenger seat.

For the data flow between the communication devices respectively the onboard server at the transport facility and the base servers at the base stations of the transport facility the onboard server is connected with one or more transmission and receiving devices respectively antennas of the transport facility. This connection occurs via known interfaces and is appropriately wired.

In a preferred form the inventive communication system includes an authentication system for identification of passengers and checking of the authorization to use the communication system. The authentication of the passenger can be achieved via chip-, barcode- or magnet cards provided by the passenger which the passenger inserts into a badge reader. Alternatively the passenger can identify himself by input of a personal user name and/or pass word. Further possibilities of authentications are the scanning finger prints or of the iris of the passenger via corresponding known features at the communication device or an identification of the passenger via voice recognition.

The authentication helps the identification respectively the allocation of the data which will be directed to the communication device at the passenger seat respectively retrievable there. On the one hand the individualization helps that only the authorized passenger receives confidential and personal data at his passenger seat. In addition the company of the transport facility can design the communication system in a way that each passenger after registration to the communication device will receive with a personal welcome or the passenger will be provided soon with a wanted work area with a pre-selection of needed software or information- and entertainment programs. By individualization the operator of the transport facility can adjust his service offers to each passenger and increase the customer loyalty respectively acceptance for the company. In addition the data flow which the passenger has not requested actively like e-mails or telephone calls can be directed and lead to the appropriate addressee. In an especially preferable form of the invention the communication device is designed in a way that after authentication to the communication device at the passenger seat, a passenger is reachable via a passenger allocated individual telephone number and/or an e-mail address for calls and data shipments.

Since the inventive communication system can provide the passenger via the communication device at the passenger seat with all data, information and tools, the passenger does not need his own hardware in the transport facility. So that the passenger can work data during the travel which he carries along on mobile pocket PC or mobile data memories it is designed in a preferable form of the invention that the data will be transferred from the mobile unit of the passenger to the base server at the base station of the transport facility prior boarding. This transmission can be achieved wireless by a radio or infrared connection or whereby the passenger connects his pocket PC or data memory to a corresponding interface. From the base server these data will be transferred to the onboard server of the transport facility and provided to the passenger via the communication device at the passenger seat during the travel. After the end of the travel the adapted data of the passenger will be sent again on request from the server of the transport facility to the base server at the base station of the destination and can be transmitted again from the base server to the mobile unit of the passenger after disembarkation of the transport facility.

Besides personal data of the passenger which will be made available to them only by authentication, passenger independent data and information are stored on the onboard server of the transport facility which will be provided during the travel to the passenger with the communication device at the passenger seat on request.

Such data and information include for example news, entertainment programs, video movies, computer games, general travel information, information on shopping opportunities on the transport facility, a selection of Internet pages like for example online news, stock market news etc. and much more.

In a preferred form the inventive communication system still includes in the transport facility and/or at the base stations output units which the passenger can operate from the communication device at the passenger seat respectively is able to transmit data to it. Such output units include for example printers via which the passenger can print out and take along after disembarkation of the transport facility documents and other information produced during the travel. Additional output units include memory features like disc, CD-ROM, electronic storage cards etc. on which the passenger can store data during the travel and afterwards can take along the memory for further treatment. Preferably the output units are located at the base station of the transport facility, which has the advantage that at the transport facility itself peripheral units have to be available as little as possible and the output units available at the base stations can be used by different transport facilities.

According to the invention it can be appropriate that the communication device at the passenger seat still includes one or more readers for memories like magnet cards, chip cards, memory cards, disc, CD-ROM or DVD so that the passenger can feed data and information of own memories carried along into the communication system. In addition it can be appropriate if the communication device at the passenger seat includes interfaces or connections respectively for the connection of mobile computers (notebook, handheld-PC, smart phone etc.) or mobile memories. This allows the passenger to use own hardware and software in connection with the communication system provided by the operator of the transport facility.

The inventive communication system allows the passenger especially the business travelers to use the travel time effectively as work time. By connection between the communication device at the passenger seat to Internet or to a company Intranet the passenger can receive, handle and transmit actual data and information basically without large time delays. He can produce documents and send directly to the receiver or can receive this in printed form at the base station after finishing the travel. He can send and receive e-mails, fax, voice messages etc. during the travel and thus use all communication features like in a conventional office.

The wired or wireless connections between the communication device at the passenger seat, the onboard server in the transport facility, the base servers at the base stations and these to the Internet or to an internal company Intranet occur via known or technologies currently under development and are not subject of the present invention. Examples for wireless data transmission technologies are Bluetooth, WLAN, RFI, infrared connections, direct or satellite supported radio connections etc. are known in the field of telecommunication. Wired data transmission technologies include all electronically, electrical and data optical bus—respectively data line technologies which are also known in the field of telecommunication.

Additional advantages, characteristics and application forms of the present invention become recognizable according to the following description and the corresponding Figures.

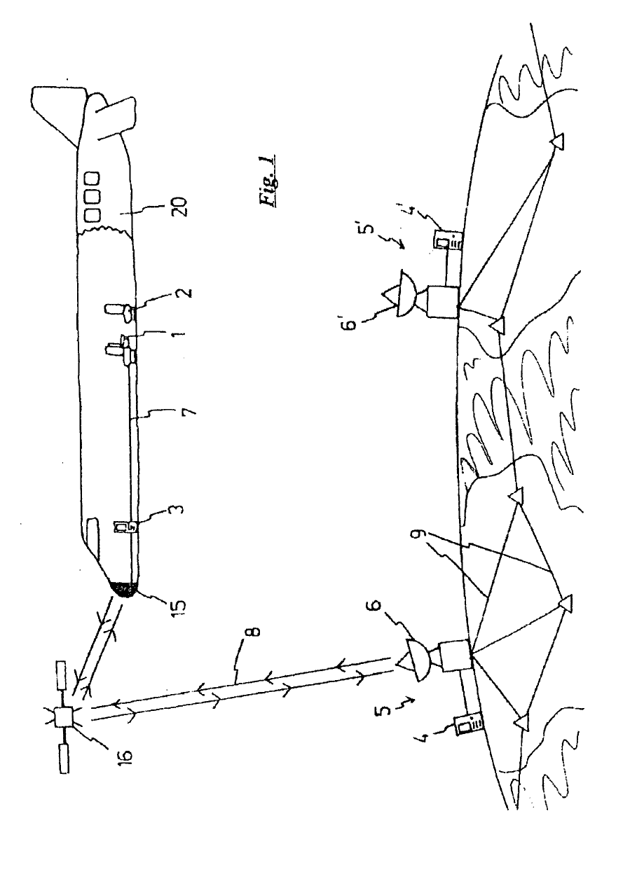

FIG. 1 is a schematic description of the inventive communication system designed for an aircraft as transport facility,

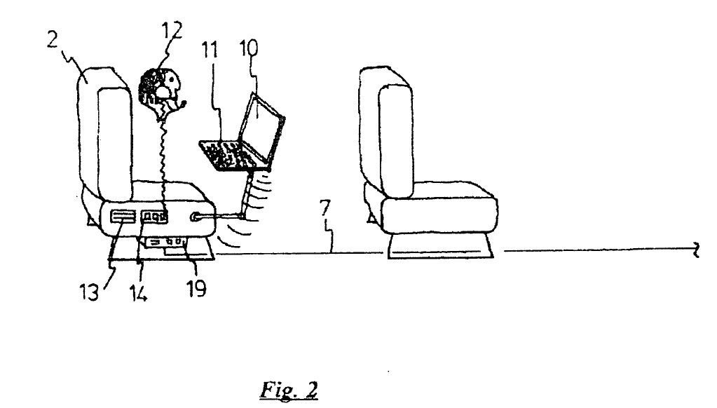

FIG. 2 is a schematic description of the inventive communication device at passenger seat at a transport facility.

FIG. 1 explains schematically the operation of the inventive communication system in connection with an aircraft as transport facility 20. All or some of the passenger seats 2 in the aircraft 20 are equipped with the inventive communication device 1. The communication device 1 at passenger seat 2 is connected via a data line 7 to the onboard server 3 in the aircraft as also the other communication devices at other passenger seats (not illustrated).

On the onboard server 3 all data are stored on installed memory features (hard disc, CD-ROM etc.) which the passenger can retrieve via the communication device 1 at his seat 2. These data include for example entertainment programs like video movies, computer movies etc. Internet pages (offline provisions of Internet contents), general information like news, stock-market prices etc. and occasionally data which the passenger has requested from the operator of the transport facility to provide prior to start of the travel like for example peculiar Internet pages etc. wanted by the passenger. The onboard server 3 at the transport facility in addition manages the use and/or transfer of data sent or requested to be received by the passenger. The onboard server 3 therefore is on wireless data exchange with one or more base servers 4,4′ at base stations 5,5′ of the transport facility for example via a radio connection. For the data exchange with the base servers 4, 4′ respectively corresponding receiver stations 6, 6′ which are in contact with the base servers the base server 3 uses a receiving and transmission system 15 on the aircraft. The connection between the aircraft and the receiving and transmission stations 6, 6′ at the base stations 5, 5′ can occur directly or also indirectly via intermediate stations, for instance satellites 16.

The base servers 4, 4′ at the base station 5, 5′ are connected to the world wide Internet, which is indicated schematically through connection line 9. The base servers 4, 4′ preferably provide further services like connections to company network of the operator of the transport facility, direct connections to company network of the passenger and/or output units via which the passenger for example can print or store on memory features personal documents or data.

If the transport facility, like the described aircraft 20 is on the ground at the base station, another connection between the onboard server and the base servers can be used as during the travel whereby the connection for example can be a radio connection designed for a short distance or also a wired connection via appropriate interfaces.

FIG. 2 shows a passenger seat 2 at a transport facility in a form of the inventive communication device with a monitor 10 as output feature and a computer keyboard 11 as input feature. According the presented form the monitor 10 and the keyboard 11 are mounted to a fixture by which they can be directed to a convenient position for the passenger. The communication device includes in addition readers 13 for memory features and magnet- or chip cards. Via those magnet- or chip cards for example the authentication of the passenger to the communication device can be managed. In addition the communication device has available connections respectively interfaces 14 via which the passenger can connect further units to the communication system. For example a notebook carried along by the passenger or a headset 12 described in the figure consisting of headphone and microphone can be connected via that the passenger can hear the tone or manage inputs by voice. Via headset 12 the passenger for example can telephone or hear the tone of video movies or music programs without thereby the seat neighbor will be disturbed.

The units of the communication device at the passenger seat are connected to the central unit 19 via cable connections or also wireless which is according to the form described in FIG. 2 allocated under the passenger seat 2. For data exchange data lines 7 lead to the onboard server of the transport facility.

Caption of Figures

1 communication device
2 passenger seat
3 onboard server at the transport facility
4, 4′ base server
5, 5′ base station
6, 6′ receiving and transmission device
7 data line between communication device and onboard server at the transport facility
8 connection between onboard server at transport facility and base server
9 network/Internet
10 display/output feature
11 input feature
12 in- and output via voice, headset
13 reader
14 connections respectively interfaces
15 transmission-/receiving system
16 satellite
17 central unit of the communication device
18 transport facility

1-13. (canceled)

14. A communication system for passengers in a transport facility, comprising:
at least one communication device at a passenger seat, wherein said at least one communication device is designed for data input into said communication system by a passenger and for data output from said communication system that a passenger can receive optically and/or acoustically;
at least one onboard server in said transport facility, wherein said at least one onboard server and said at least one communication device are designed for at least one of wireless and wired data exchange with one another; and
at least one base server at at least one base station of said transport facility, wherein said at least one onboard server is designed for at least one of wireless and wired data exchange with said at least one base server, and wherein said at least one base server is connected for a data exchange with at least one of an open and a closed network.

15. A communication system according to claim 14, wherein said at least one communication device is provided with a screen, preferably an LCD screen, for visual outputs.

16. A communication system according to claim 14, wherein for acoustical output said at least one communication device includes at least one of an integrated loud speaker and a wireless headset or a wired headset that is connected to said at least one communication device.

17. A communication system according to claim 14, wherein for inputs by passengers, said at least one communication device is provided with at least one of a computer keyboard, a touch screen, a microphone and a computer mouse.

18. A communication system according to claim 14, wherein a mounting fixture for said at least one communication device is provided at a passenger seat.

19. A communication system according to claim 18, wherein said mounting fixture is a flexible or pivotable arm to which said at least one communication device can be connected in a fixed or removable manner.

20. A communication system according to claim 14, wherein a slot for receiving said at least one communication device is provided at said passenger seat preferably in an armrest of said passenger seat.

21. A communication system according to claim 20, wherein said slot is provided with a charging station for recharging batteries of said at least one communication device.

22. A communication system according to claim 14, wherein said at least one onboard server is connected to at least one sending and receiving device or antenna of said transport facility.

23. A communication system according to claim 14, which further comprises an authentication system for identifying passengers and checking their authority to use said communication system.

24. A communication system according to claim 23, wherein after authentication, a passenger is reachable for telephone calls and data transfer at said at least one communication device at a passenger seat via at least one of an individual telephone number, e-mail address, and internet address assigned to said passenger.

25. A communication system according to claim 14, wherein via said at least one communication device, passenger seat functions, such as seat position, heating, air-conditioning, and lighting, are adjustable, and/or information, entertainment programs, application programs stored on said at least one onboard server in said transport facility, and/or passenger specific or public data, are retrievable and workable.

26. A communication system according to claim 14, which further comprises at least one reader for magnet cards, chip cards, memory cards, disks, CD-ROMs or DVDs, and/or connections or interfaces for the connection of mobile computers or mobile mass memories.

27. A communication system according to claim 14, wherein in said transport facility and/or at said at least one base station output devices, preferably printers and data storage means, are provided that can be activated by said at least one communication device at said passenger seat.
